(19) United States
(12) Patent Application Publication
(10) Pub. No.: US 2020/0038986 A1
(43) Pub. Date: Feb. 6, 2020

(54) METHODS AND PROCESSES FOR CNC TOOL BASED GRATING PROCESSING

(71) Applicant: INOVATECH ENGINEERING CORPORATION, VANKLEEK HILL (CA)

(72) Inventors: MIGUEL CLEMENT, ST PASCAL (CA); STEPHANE MENARD, COTEAU-DU-LAC (CA); DOMINIQUE BRUNEAU, ORLEANS (CA); DAVID GABRIELS, EGBERT (CA)

(21) Appl. No.: 16/530,007

(22) Filed: Aug. 2, 2019

Related U.S. Application Data
(60) Provisional application No. 62/713,618, filed on Aug. 2, 2018.

(51) Int. Cl. B23K 10/00; B23K 37/02; B23K 37/047

(52) U.S. Cl. CPC B23K 10/006; B23K 37/047; B23K 37/0258

(57) ABSTRACT

Computer numerical control (CNC) machines have dramatically changed manufacturing processes including plasma based cutting. Typically, plasma based cutting executes a single continuous process. However, gratings cut from a grating sheet require a number of discrete cuts be made within a grating sheet to cut each element within the grating sheet to isolate the element required from the grating. Accordingly, embodiments of the invention provide enterprises and facilities employing CNC cutting systems with a means to overcome the limitations of CNC cutting systems when cutting such elements.

### CROSS-REFERENCE TO RELATED APPLICATIONS

This application claims the benefit of priority from U.S. Provisional patent application 62/713,618 filed Aug. 2, 2018 entitled “Methods and Processes for CNC Tool Based Grating Processing”, the entire contents of which being incorporated herein by reference.

### FIELD OF THE INVENTION

This invention relates to computer numerical control machine tools and more particularly to usability enhancements relating to cutting tools and cutting gratings from grating sheets.

### BACKGROUND OF THE INVENTION

Numerical Control (NC) is the automation of machine tools that are operated by precisely programmed commands encoded on a storage medium, as opposed to controlled manually via hand wheels or levers, or mechanically automated via cams alone. Most NC today is computer (or computerized) numerical control (CNC), in which local and/or remote computers provide the data files for execution by the machine tool(s). CNC systems allow end-to-end component design to highly automated using computer-aided design (CAD) and computer-aided manufacturing (CAM) programs. The programs produce a computer file that is interpreted to extract the commands needed to operate a particular machine via a post processor, and then loaded into the CNC machines for production.

As a particular component might require the use of a number of different tools, e.g. drills, saws, etc., modern machines often combine multiple tools into a single “cell”. In other installations, a number of different machines are used with an external controller and human or robotic operators move the component from machine to machine. In either case, the series of steps needed to produce any part is highly automated and produces a part that closely matches the original CAD design.

This has made CNC based manufacturing a common foundation to many high volume products. Accordingly, the time taken for the CNC machine(s) to execute the sequence of processes becomes a dominant factor in the cost and throughput of a CNC production station and/or CNC production line. However, some structures at present are difficult to process upon CNC machines such as plasma cutters such as gratings cut from a grating sheet or grating sheets. Accordingly, it would be beneficial to provide enterprises with a means to automate the cutting of grating structures from one or more grating sheets. It would be beneficial for the automation to exploit automated camera based image acquisition and processing to define the position, spacing, orientation, etc. of the grating elements within the one or more grating sheets allowing the positions of grating elements to be cut to be defined from a template of the grating to be provided from the process. Alternatively, it would be beneficial to provide a user of a CNC machine with a means to define a grid overlaying a grating sheet or portion of a grating sheet allowing the grating sheet to be placed without any specific due care to position and/or orientation on the tool bed.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to computer numerical control machine tools and more particularly to usability enhancements relating to cutting tools and cutting gratings from grating sheets.

In accordance with an embodiment of the invention there is provided a method comprising:
acquiring a plurality of images, each image acquired with a camera of one or more grating sheets upon a computer controlled cutting machine tool (CU-MATCO) where each grating sheet comprises a plurality of grating elements in a predetermined pattern;
processing the plurality of images with a microprocessor to define a plurality of sets of location data, each set of location data defining at least one of a grating element within the one or more grating sheets and a cross-over between a pair of grating elements within the one or more grating sheets;
retrieving from a database a template of a grating to be cut from the one or more grating sheets;
generating with the microprocessor a plurality of cut locations, each cut location representing a location upon a grating element of the plurality of grating elements at which a cut should be made within the grating element of the plurality of grating elements, the plurality of cut locations being established in dependence upon the template and the plurality of sets of location data; and
making each cut of the plurality of cuts with a cutter forming part of the CU-MATCO.

In accordance with an embodiment of the invention there is provided a method comprising:

acquiring a location of a cut to be made upon a grating element within a grating sheet;
making the cut with a cutter on computer controlled machine tool; wherein
making the cut comprises:
moving the cutter to a predetermined position relative to the grating element being cut;
moving the cutter to a first predetermined height relative to the grating element being cut;
moving the cutter in a first direction from the predetermined position to a first edge of the grating element being cut;
upon detecting the first edge of the grating element being cut moving the cutter to a second predetermined height relative to the grating element being cut and waiting for a first predetermined time;
moving the cutter to the predetermined position relative to the grating element being cut;
moving the cutter to the first predetermined height relative to the grating element being cut;
moving the cutter in a second direction from the predetermined position to a second edge of the grating element being cut; and
upon detecting the second edge of the grating element being cut moving the cutter to a third predetermined height relative to the grating element being cut and waiting for a second predetermined time.

In accordance with an embodiment of the invention there is provided a method comprising:
acquiring a plurality of images, each image acquired with a camera of one or more grating sheets upon a computer controlled cutting machine tool (CU-MATCO) where each grating sheet comprises a plurality of grating elements in a predetermined pattern;
processing the plurality of images with a microprocessor to define a combined image, the combined image being of a predetermined portion of the grating sheet;
displaying the combined image to a user within a graphical user interface together with a grid template, the grid template comprising a grid having a plurality of vertices representing a virtual grating sheet;
providing the user with the ability to move any vertex of the plurality of vertices to align the grid template with the combined image;
retrieving from a database a template of a grating to be cut from the one or more grating sheets;
generating with the microprocessor a plurality of cut locations, each cut location representing a location upon the one or more grating sheets established in dependence upon the template and the aligned grid template; and
making each cut of the plurality of cuts with a cutter forming part of the CU-MATCO.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a machine shop hub supporting communications to a network such as depicted in FIG. 1 and as supporting embodiments of the invention with respect to machine tool settings and profiles;

FIG. 3 depicts exemplary plasma cutting machine tool systems generating and exploiting configuration settings established and verified according to embodiments of the invention;

FIG. 4 depicts examples of grating sheets requiring cutting processes according to embodiments of the invention;

FIG. 5 depicts an exemplary infrastructure deployment of gratings which may be processed in a single processing sequence according to embodiments of the invention;

FIG. 6 depicts an exemplary grating structure processed according to an embodiment of the invention;

FIGS. 7 to 9 depict schematically the processing of multiple grating sheets to provide a grating for deployment exploiting embodiments of the invention;

FIGS. 10 and 11 depict an exemplary alignment of a grating grid to physical gratings within a processing tool according to an embodiment of the invention;

FIG. 12 depicts an exemplary tool process for cutting a grating element according to an embodiment of the invention;

FIG. 13 depicts a plasma tool at different points within the exemplary tool process for cutting a grating element according to an embodiment of the invention depicted in FIG. 12;

FIGS. 14 and 15 depict images from a plasma tool exploiting an exemplary tool process according to an embodiment of the invention to cut a defined grating element from a grating sheet; and

FIG. 16 depicts captured and processed images of grating cross-overs within a grating to determine the grating grid and cutting locations according to an embodiment of the invention.

### DETAILED DESCRIPTION

The present invention is directed to computer numerical control machine tools and more particularly to the usability enhancements relating to cutting tools and cutting gratings from grating sheets.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface (GUI).

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “machine tool” (tool) as used herein, and throughout this disclosure, refers to a machine for shaping or machining or assembling metal or other rigid materials, usually by cutting, boring, drilling, grinding, shearing, or other forms of deformation in conjunction with welding, brazing and other forms of material joining. Machine tools employ some sort of tool that does the cutting or shaping which may be fixed or removable/changeable. Machine tools generally have some means of constraining the workpiece and/or providing a guided movement of the parts of the machine and workpiece. Thus, the relative movement between the workpiece and the cutting tool (which is called the toolpath) is controlled or constrained by the machine to at least some extent. Some machine tools may work on a single piece part at a time whilst others may work on multiple piece parts or generate multiple piece parts from a single piece of starting stock material. Some machine tools may only provide a single process, e.g. drilling, whilst other tools such as milling machines may provide multiple processes. Such machine tools may include, but not be limited to, drill presses, lathes, screw machines, milling machines, shears, saws, planers, grinding machines, electrical discharge machining, plasma cutters, laser cutters, laser engravers, grinders, electrical discharge welders, shot peening, and water jet cutters/surface machining.

A “profile” as used herein, and throughout this disclosure, refers to a computer and/or microprocessor readable data file comprising data relating to settings and/or limits and/or sequence for a machine tool or other item of manufacturing equipment.

A “grating” or “grating sheet” as used herein, and throughout this disclosure, refers to an element or sheet formed from a regularly spaced collection of essentially identical, parallel, elongated elements. Such gratings typically consist of two sets of elongated elements, within a second set being usually perpendicular to the first. Where the two sets are perpendicular, this is also known as a grid or a mesh. Typically, such gratings are employed in providing infrastructure elements such as decks on bridges, footbridges, catwalks, etc. and in such applications are formed from steel, stainless steel, galvanized steel, etc. Typically, a grating sheet is 4 feet (approximately 122 cm) or 2 feet (approximately 61 cm) wide by 8 feet (approximately 244 cm) panel which is cut to the desired shape. Due to the periodic nature of the sets of perpendicular elongated elements continuous processing via plasma cutting, for example, is not feasible.

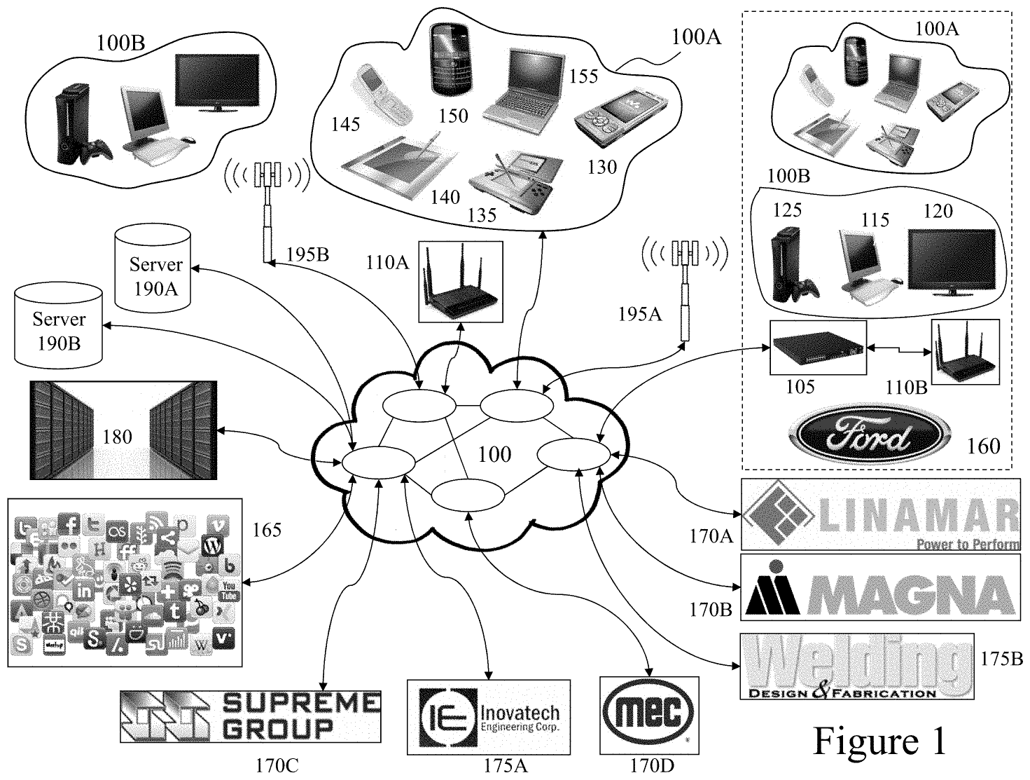

Referring to FIG. 1 there is depicted a network environment 100 within which embodiments of the invention may be employed supporting machine tool systems, applications, and platforms (MTSAPs) according to embodiments of the invention. Such MTSAPs, for example supporting multiple channels and dynamic content. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, such as Ford™ for example, within which other first and second user groups 100A and 100B are disposed. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are Social Networks (SOCNETS) 165, first manufacturer 170A, e.g. Linamar™; second manufacturer 170B, e.g. Magna™; steel fabricator 170C, e.g. Supreme Group™; manufacturing solutions provider 170D, e.g. Mayville Engineering Corp.; machine tool manufacturer 175A, e.g. Inovatech Engineering; and online chat/discussion/bulletin board/forum 175B, e.g. Welding Design and Fabrication (http://weldingweb.com/); as well as first and second servers 190A and 190B which together with others, not shown for clarity. Accordingly, a user employing one or more MTSAPs may interact with one or more such providers, enterprises, service providers, retailers, third parties etc. and other users. First and second servers 190A and 190B may host according to embodiments of the inventions multiple services associated with a provider of adult device systems, applications, and platforms (MTSAPs); a provider of a SOCNET or Social Media (SOME) exploiting MTSAP features; a provider of a SOCNET and/or SOME not exploiting MTSAP features; a provider of services to PEDS and/or FEDS; a provider of one or more aspects of wired and/or wireless communications; an Enterprise 160 exploiting MTSAP features; license databases; content databases; image databases; content libraries; customer databases; websites; and software applications for download to or access by FEDs and/or PEDs exploiting and/or hosting MTSAP features. First and second primary content servers 190A and 190B may also host for example other Internet services such as a search engine, financial services, third party applications and other Internet based services.

Accordingly, a user may exploit a PED and/or FED within an Enterprise 160, for example, and access one of the first or second primary content servers 190A and 190B respectively to perform an operation such as accessing/downloading an application which provides MTSAP features according to embodiments of the invention; execute an application already installed providing MTSAP features; execute a web based application providing MTSAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

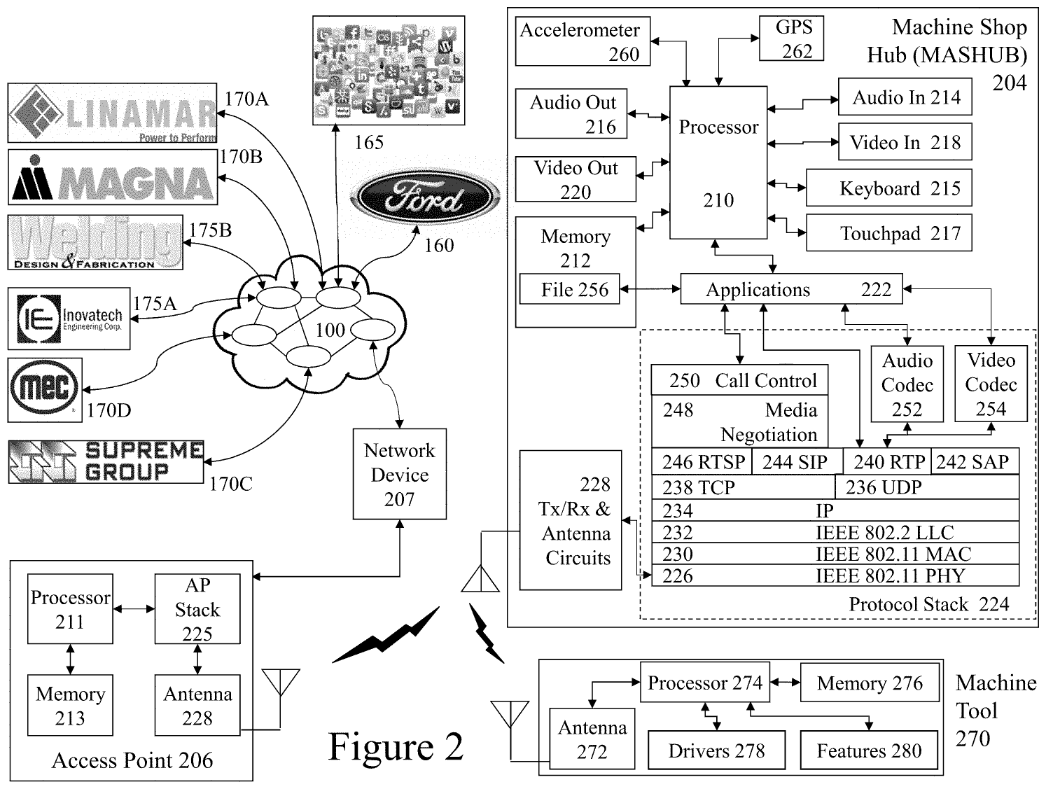

Now referring to FIG. 2 there is depicted a Machine Shop Hub (MASHUB) 204 and network access point 207 supporting MTSAP features according to embodiments of the invention. MASHUB 204 may, for example, be a PED and/or FED and may include additional elements above and beyond those described and depicted. Also depicted within the MASHUB 204 is the protocol architecture as part of a simplified functional diagram of a system 200 that includes an MASHUB 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, first manufacturer 170A, e.g. Linamar™; second manufacturer 170B, e.g. Magna™; steel fabricator 170C, e.g. Supreme Group™; manufacturing solutions provider 170D, e.g. Mayville Engineering Corp.; machine tool manufacturer 175A, e.g. Inovatech Engineering; and online chat/discussion/bulletin board/forum 175B, e.g. Welding Design and Fabrication (http://weldingweb.com/); as well as first and second servers 190A and 190B and Enterprise 160, Ford™.

The MASHUB 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

MASHUB 204 may include an audio input element 214, for example a microphone, and an audio output element 216, for example, a speaker, coupled to any of processors 210. MASHUB 204 may include a video input element 218, for example, a video camera or camera, and a video output element 220, for example an LCD display, coupled to any of processors 210. MASHUB 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the MASHUB 204. The one or more applications 222 that are typically stored in memory 212 and are executable by any combination of processors 210. MASHUB 204 also includes accelerometer 260 providing three-dimensional motion input to the process 210 and GPS 262 which provides geographical location information to processor 210.

MASHUB 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Tx/Rx & Antenna Circuits 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238. Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206.

Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230. It would be apparent to one skilled in the art that elements of the MASHUB 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed MASHUBs represented by MASHUB 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted is Machine Tool (MACTO) 270 which is coupled to the MASHUB 204 through a wireless interface between Antenna 272 and Tx/Rx & Antenna Circuits 228 wherein the MASHUB 204 may support, for example, a national wireless standard such as GSM together with one or more local and/or personal area wireless protocols such as IEEE 802.11 a/b/g WiFi, IEEE 802.16 WiMAX, and IEEE 802.15 Bluetooth for example. The Antenna 272 is connected to Processor 274 and therein to Memory 276, Drivers 278, and Features 280. Accordingly, the MACTO 270 may operate as standalone device with factory installed control routines accessed through an interface on the MACTO 270, not shown for clarity, or through an application in execution upon the MASHUB 204. Subsequently, as described below one or more of these control routines may be modified, amended, deleted etc. whilst other new control routines may be created, acquired, installed etc.

Accordingly, it would be evident to one skilled the art that the MACTO 270 with associated MASHUB 204 may accordingly download original software and/or revisions for a variety of functions supported by the drivers 278 and/or features 280. In some embodiments of the invention the functions may not be implemented within the original as sold MACTO 270 and are only activated through a software/firmware revision and/or upgrade either discretely or in combination with a subscription or subscription upgrade for example. Whilst the MASHUB 204, MACTO 270 and AP 206 are depicted exploiting wireless communications it would be evident that in other embodiments of the invention one or more of these wireless communication paths may be replaced with a wired connection or a non-wireless but unwired connection such as an optical link for example or not implemented and communications are through the AP 206 for example between MACTO 270 and MASHUB 204 or even via the network 100.

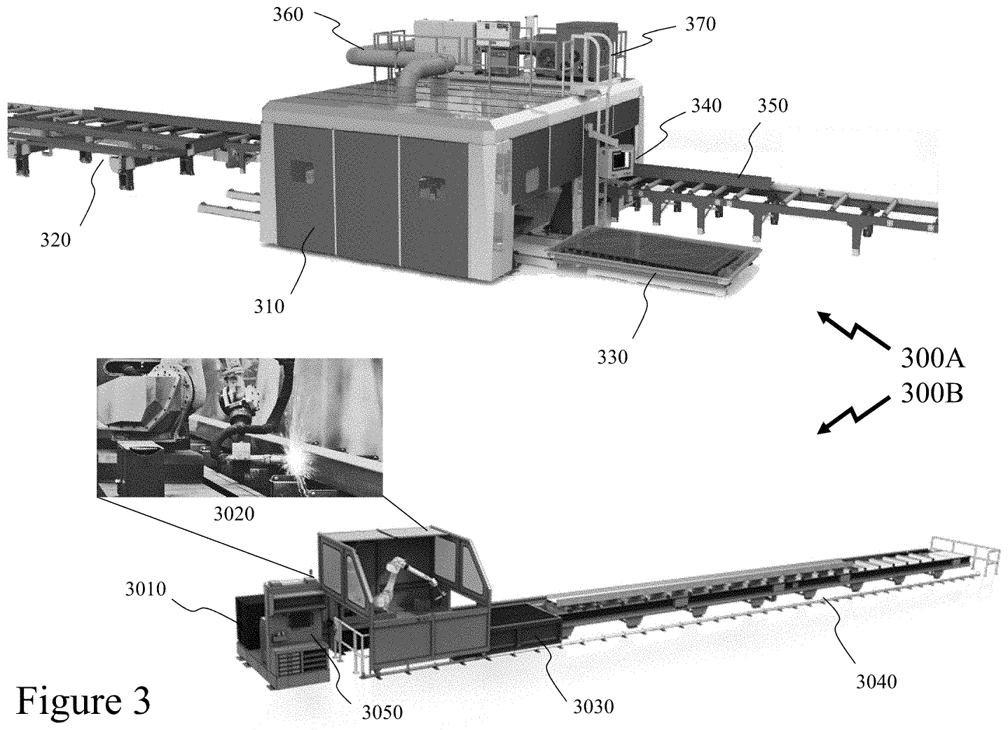

Now referring to FIG. 3 there are depicted first and second schematics 300A and 300B of plasma cutting machine tool systems as manufactured by Inovatech Engineering which may generate, and exploit machine tool settings/configuration profiles as established, verified, and acquired according to embodiments of the invention. Accordingly, each of the plasma cutting machine tool systems in first and second schematics 300A and 300B may be an example of a MACTO 270 in FIG. 2. Considering initially first schematic 300A then:
Robot enclosure 310, provides an environment containing fumes, reducing noise etc.;
Cross-transfer 320, which allows different load/unload profiles to be employed as well as materials receipt/processed material delivery, etc. and saves time;
Plate table 330, provides base for sheet/plate as moved relative to plasma cutter where typical configurations include 6″×10″ (2 m×3 m), 12′×10′ (4 m×3 m), and 24′×10″ (8 m×3 m);
Operator station 340, wherein an industrial computer controls plasma robot, conveyors, plate table, etc. and displays messages, alarms, maintenance screens, plasma control settings etc.;
Infeed/outfeed conveyors 350; chain or belt driven conveyors allow material to be received from stock/prior MACTO 270 and/or transferred to finished stock/next MACTO 270.
Ventilation system 360, which provides automatic fume extraction and filtering etc.; and
Plasma gas control etc. 370, with automated gas control etc. for different cutting processes adapted to plasma cutter head, material processed, etc.

Now referring to second schematic 300B then:
Plasma gas control etc. 3010, with automated gas control etc. for different cutting processes adapted to plasma cutter head, material processed, etc.
6-axis robot 3020, with plasma cutter head allowing control over head position, orientation and movement of plasma cutter head relative to the piece part independent of any motion of the piece part which as depicted is within an enclosure that moves along the profile table 3040 reducing overall space requirements;
Water 3030, optionally inserted in line for quenching, cutting stiffener plates, etc.;
Profile table 3040 which supports the piece-part(s) and allows for laser piece-part scanning and alignment of the piece-part on the profile table; and
Operator station 3050, wherein an industrial computer controls plasma robot, conveyors, plate table, etc. and displays messages, alarms, maintenance screens, plasma control settings etc.

Accordingly, the operator stations 340 and 3050 in first and second schematics 300A and 300B (hereinafter operator station), acting for example as MACTO 270 with optional communications to a central machine shop system, e.g. MASHUB 204, or acting a MASHUB 204 in a stand-alone configuration provides the required control settings to the computer controlled elements of the plasma cutting machine tool system such as robot (not shown for clarity), plasma cutting tool, and plate table for example. These may be selected from a menu of control setting profiles defined, for example, by product name/product serial number etc. stored upon the operator station or alternatively the operator station retrieves the control setting profile from a remote system such as MASHUB 204. Accordingly, when the operator triggers execution of a machine tool profile (MACPRO) that defines the control settings of the plasma cutting system, in this instance although it would be evident that the MACTO 270 may be any other machine tool accepting computer numerical control (CNC) etc., together with the motion sequence of the robot and plate table as well as in other instances cross-transfer 320, infeed/outfeed conveyors 350, profile table 3050, etc.

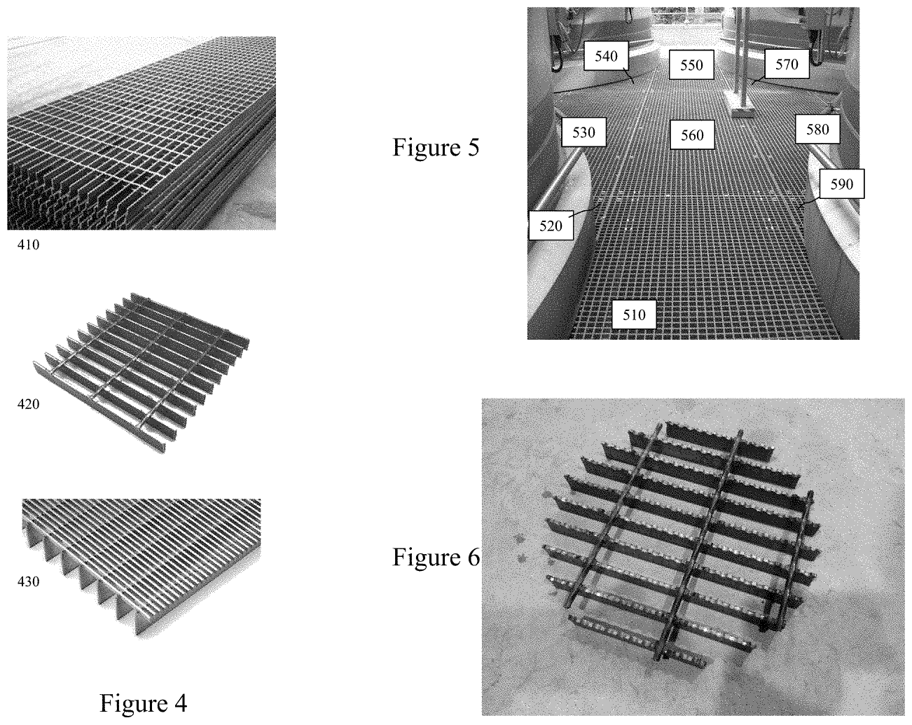

FIG. 4 depicts examples of grating sheets requiring cutting processes according to embodiments of the invention. Sheet 410 representing a typical “as manufactured” sheet obtained from a manufacturer being 4 feet (approximately 122 cm) or 2 feet (approximately 61 cm) wide by 8 feet (approximately 244 cm) from which the required grating elements are cut such first grating 420. Gratings and grating sheets may employ different elongated element geometries for the long axis (e.g. 8 feet (approximately 244 cm)) and short axis (e.g. 4 feet (approximately 122 cm) or 2 feet (approximately 61 cm)). For example, first grating 420 employs a sheet comprising rectangular bars along the long axis joined by spiral rods along the short axis. In contrast second grating 430 employs rectangular bars along the long axis joined by small rectangular bars along the short axis. Typically, the pitch of long axis elements of the grating sheet is 1″ (approximately 25 mm) or 2″ (approximately 50 mm) whilst the pitch of short axis elements is 2″ (approximately 50 mm) or 4″ (approximately 100 mm). However, second grating 430 has a pitch of short axis elements of 0.5″ (approximately 12.5 mm). Accordingly, a wide range of grating sheet geometries may be employed with rectangular, square, circular cross-section short axis elements with typically rectangular long axis elements although other geometries, pitches, element dimensions, may be employed.

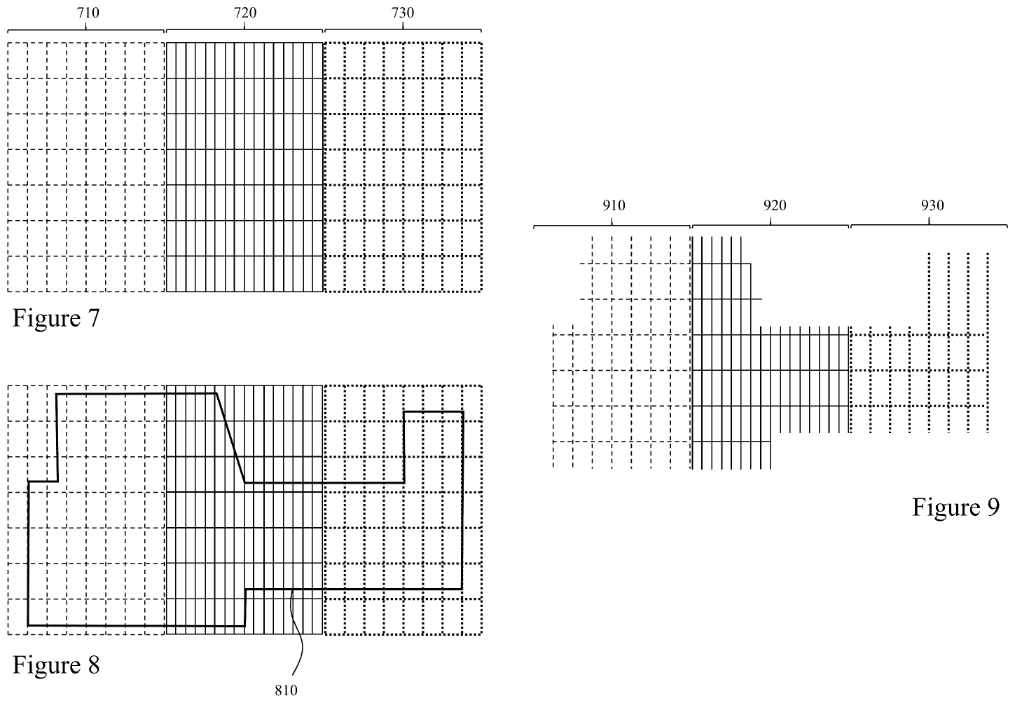

However, they all when being processed to form an infrastructure deployment such as depicted in FIG. 5 require that each long axis element and short axis element is cut. With complex shape for the resulting infrastructure grating element this cutting is generally performed as a series of discrete cutting operations on each long axis element and short axis element. Further, where the resulting infrastructure is large then multiple sheets may require deployment and cutting for the overall geometry required. Again, within the prior art each sheet of the multiple sheets is processed individually. The result is slow processing with high labour cost and increased waste and cost where multiple sheets are required due to errors in processing.

Accordingly, the inventors have established a process for a plasma based robot cutting system allowing multiple sheets to be placed and processed in a single operation ensuring alignment of the multiple sheets wherein the robot cutting system performs sequential cutting processes upon the grating based upon knowledge of the deployed grating and the desired template to be cut. For example, considering FIG. 5 then depicts an exemplary infrastructure deployment of gratings which may be processed in a single processing sequence according to embodiments of the invention. Within FIG. 5 first to ninth grating sheets 510 to 590 are identified although the number of sheets is higher as evident to one of skill in the art viewing the Figure. These being:
First sheet 510 comprising a nearly complete grating sheet with curved edges removing portions on either side;
Second sheet 520 being a small portion of a grating sheet with curved edge;
Third sheet 530 being a sheet with curved section removed;
Fourth sheet 540 being a portion of a grating sheet with curved edge;
Fifth sheet 550 being substantially like first sheet 510;
Sixth sheet 560 being a complete grating sheet;
Seventh sheet 570 being a portion of a grating sheet with curved edge;
Eighth sheet 580 being a sheet with curved section removed; and
Ninth sheet 590 being a small portion of a grating sheet with curved edge.

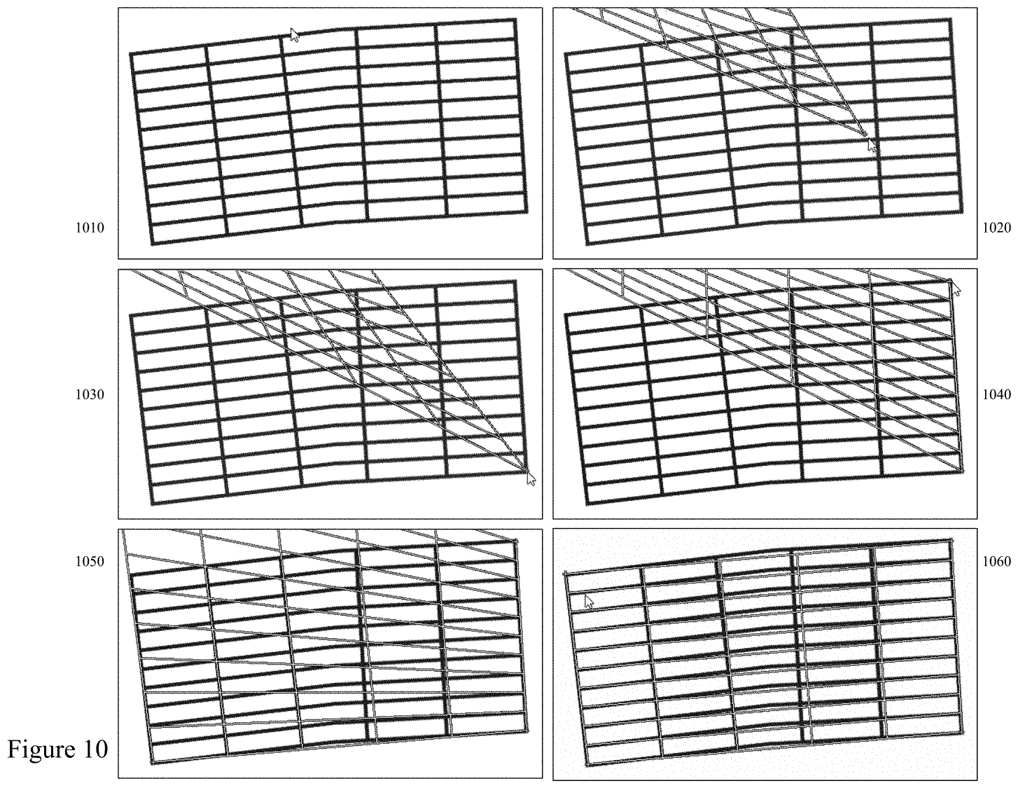

FIG. 6 depicts an exemplary grating structure processed according to an embodiment of the invention wherein a circular grating element has been cut from a grating sheet requiring the execution of 20 cuts on long axis rectangular elements at 1″ spacing and 6 cuts on short axis twisted circular rods on 4″ spacing.

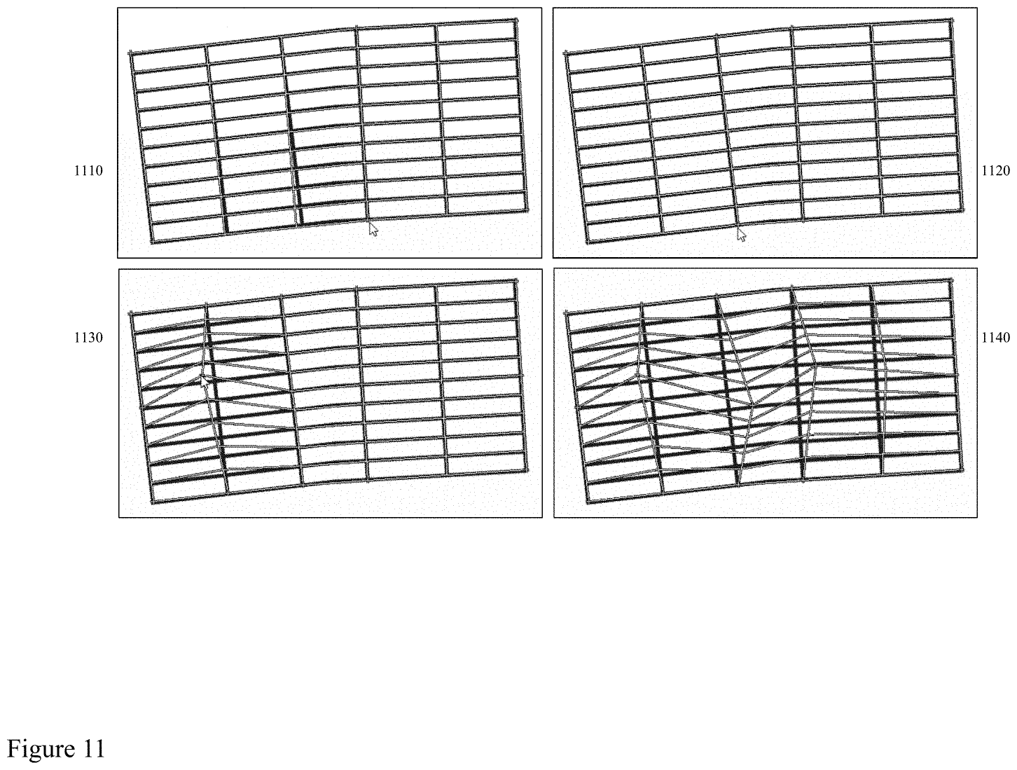

FIGS. 7 to 9 depict schematically the processing of multiple grating sheets to provide a grating for deployment exploiting embodiments of the invention. Referring initially to FIG. 7 three grating sheets 710 to 730 are depicted, using different line types for clarity of differentiating each grating sheet. Next in FIG. 8 a grating design 810 is overlaid to the three grating sheets 710 to 730 respectively. According, where the grating design 810 crosses a long element or short element then a cut is required at that point upon that respective sheet of the grating sheets 710 to 730 respectively in order to generate the overall grating element from the cut portions of each of the grating sheets 710 to 730 respectively. Next in FIG. 9 the resulting cut grating sheets 910 to 930 are depicted. As depicted first and third grating sheets 710 and 730 have long axis elongated elements at a different spacing to that of the second grating sheet 720.

Within an embodiment of the invention the cutting machine tool (CU-MACTO) the grating sheets 710 to 730, from which the cut grating sheets 910 to 930 are formed, may be defined to the CU-MACTO through a database of stored grating sheets which defines for each grating sheet data including, but not limited to, the long axis element pitch, short axis pitch, long axis element geometry and dimensions, short axis element geometry and dimensions, material, etc. Accordingly, the CU-MACTO may exploit a camera and image processing to define the geometry and alignment of a grating sheet placed upon a tool bed of the CU-MACTO for processing.

Optionally, the CU-MATCO may exploit image processing to align multiple acquired images so that the images are at an appropriate resolution for defining grating elements within the one or more grating sheets. Optionally, rather than acquiring a full image of the grating sheets(s) to align the template to the process may be modified to capture an image or images of the grating sheet, apply image processing to define grating elements, process to define the appropriate cuts to be made relative to the grating sheet/template and make these before moving to another portion of the grating sheet.

Accordingly, a user may, such as described within U.S. Provisional 62/536,700 entitled “Usability Enhancements for CNC Tools” filed 25 Jul. 2017 and U.S. Formal “Direct Client Initiated CNC Tool Setting” filed Mar. 6, 2017 the entire contents of both being herein incorporated by reference, may align and position a template for a grating to be cut with respect to the grating sheet. Accordingly, the CU-MACTO may then based upon the template, the specification of the grating sheet, and the orientation of the grating sheet define the intersection points of the template with respect to the grating sheet which represent the grating elements that require cutting in order to separate the grating element defined by the template from the grating sheet.

Alternatively, within an embodiment of the invention the CU-MACTO may exploit the template based upon the alignment provided by the user and proceed to traverse the template from a starting point wherein the presence of a long axis or short axis element is defined through a camera and image processing and knowledge of the distance traversed, image acquired, and grating sheet design employed to define whether the axis element encountered is a long axis or short axis element such that the appropriate cutting routine may be employed, as the short axis elements may be circular rods whilst the long axis elements rectangular bars.

Accordingly, as depicted in FIGS. 7 to 9 the CU-MACTO may therefore automatically generate multiple piece-parts for a single grating infrastructure item from multiple sheets placed upon the tool bed of the CU-MACTO. Within Figured 7 to 9 respectively the multiple grating sheets have been placed upon the tool bed of the CU-MACTO aligned and positioned within the correct sequence. However, within another embodiment of the invention the CU-MACTO may partition the template into multiple template piece-parts based upon the initial position of the template upon a first grating sheet of the multiple grating sheets or exploit pre-set template piece-parts which are employed.

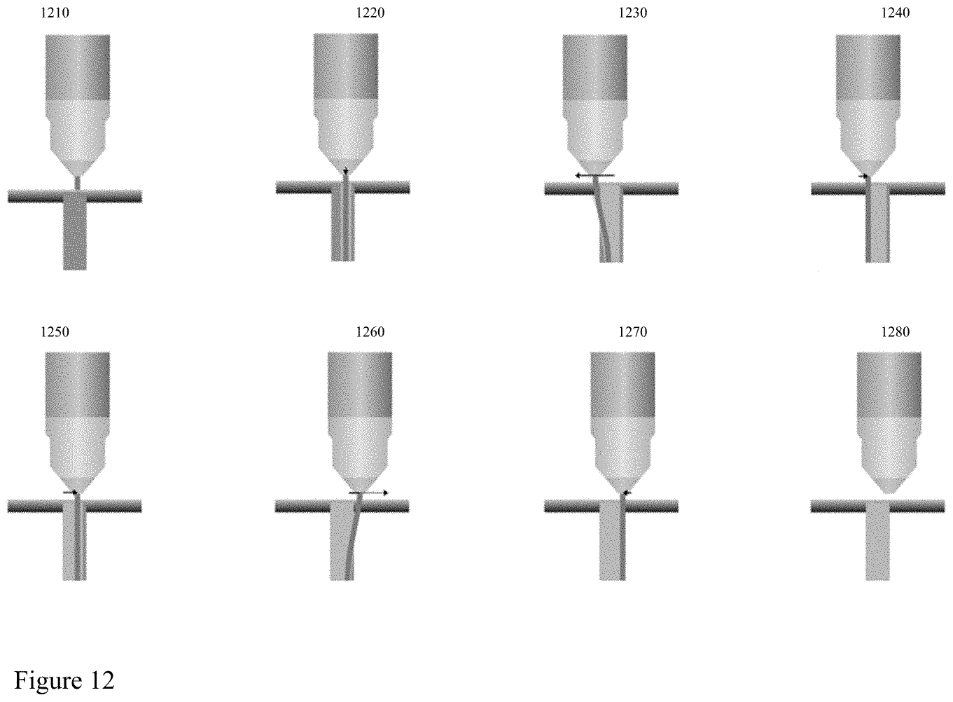

Alternatively, within other embodiments of the invention a user of a CU-MACTO may orientate and align a grating grid to a physical grating upon the tool bed of the CU-MACTO. Such an embodiment being depicted in respect of FIGS. 10 and 11. Whilst in most applications it is anticipated that the embodiments of the invention are employed in conjunction with regular grating sheets maximum flexibility of embodiments of the invention includes the ability for CU-MACTOs exploiting embodiments of the invention to exploit non-uniform gratings or custom gratings. Accordingly referring to FIG. 10 there are depicted first to sixth images 1010 to 1060 respectively whilst in FIG. 11 there are depicted seventh to tenth images 1110 to 1140 respectively. Accordingly, within FIG. 10 the first to sixth images 1010 to 1060 respectively depict:
First image 1010 wherein a captured representation of a grating is depicted;
Second image 1020 wherein a user is dragging a first corner of a grating template within a GUI relative to the grating image;
Third image 1030 wherein the user has aligned the first corner of the grating template within the GUI relative to the grating image;
Fourth image 1040 wherein the user has aligned a second corner of the grating template within the GUI relative to the grating image;
Fifth image 1050 wherein the user has aligned a third corner of the grating template within the GUI relative to the grating image;
Sixth image 1060 wherein the user has aligned a fourth corner of the grating template within the GUI relative to the grating image.

However, it is evident that the grating template when aligned to the four corners does not align completely to acquired grating image. Accordingly, the user proceeds to further modify the grating template as depicted within FIG. 11 in first to fourth images 1110 to 1140 respectively depict:
Seventh image 1110 wherein the user has aligned an intermediate corner of the grating template within the GUI relative to the grating image;
Eighth image 1120 wherein the user has aligned another intermediate corner of the grating template within the GUI relative to the grating image such that the grating template now aligns to the grating image.

FIGS. 10 and 11 depict an exemplary alignment of a grating template to physical gratings within a processing tool according to an embodiment of the invention. Whilst first to sixth images 1010 to 1060 and seventh to eighth images 1110 and 1120 the user has aligned the grating template to an image of the grating plate. As evident from ninth and tenth images 1130 and 1140 respectively the user is able to grab any cross-point (intersection of a long axis element with a short axis element) within the grating template and manipulate these. Accordingly, the user can align the grating template to even non-uniform gratings, damaged gratings, etc. in order to establish a grating template from which cutting points can be defined from a grating design. Further, the user may through other manipulations, not shown, linearly scale different portions of the grating template, move sections of the grating template as a group, rotate sections of the grating template etc. In this manner the user can align the grating template to a range of different gratings as well as to a single grating, a pair of gratings, multiple gratings etc. With two or more gratings to which a grating template is aligned a single grating formed from multiple grating sheets can be cut in a single processing sequence. Accordingly, as depicted in FIGS. 7 to 9 starting with grating sheets 710 to 730 in FIG. 7 a single grating template can be formed to overlay the grating sheets as laid on the tool bed of the CU-MACTO. However, the grating sheets 710 to 730 do not have to be orientated and/or aligned accurately upon the tool bed as the grid template can be aligned to the actual placement of the grating sheets 710 to 730 and then the cutting points defined from the grating design, e.g. grating design 810.

Alternatively, within another embodiment of the invention the CU-MATCO may measure the grating sheet and spacing of long and short axis elements in order to define a grid based upon the actual grating sheet/CU-MATCO system so that any non-linearity in the CU-MATCO or grating sheet. The measurements of the grating sheet may be performed using a camera and image processing upon the CU-MATCO discretely or in combination with force/contact detection of a sensing arm, plasma torch, etc. of the CU-MATCO. Based upon the images and processing of the images a plurality of sets of data may be established. Each set of data defining a grating element within a grating sheet. A set of data may include one or more of the following for the grating element, a first end position, a second end position, a length, and an angular orientation. The set of data may also include information derived in respect to a specification of the grating sheet based upon a selection made by the user, wherein such data may include material composition, grating element dimensions, and grating geometry for example.

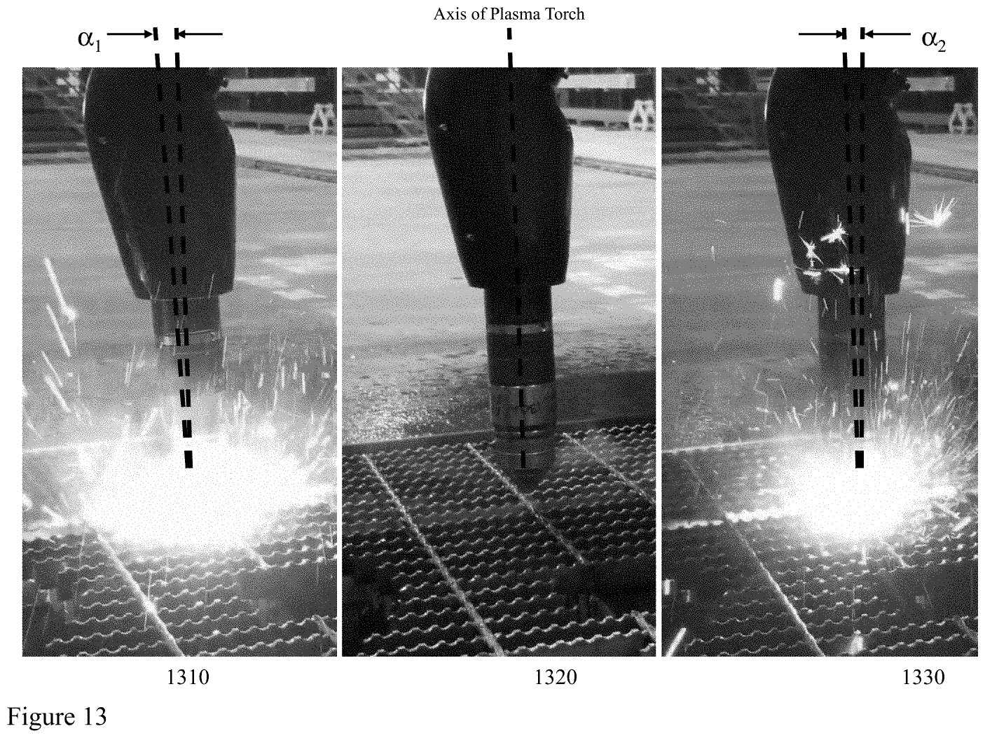

Accordingly, referring to FIG. 12 there is depicted an exemplary tool process for cutting a grating element according to an embodiment of the invention. The cut being performed at a point such as defined by the overlay of a grating template with a grating sheet such as exemplified within embodiments of the invention in FIGS. 7 through 11 respectively. A PLATO employs a thermal plasma generated via by direct current (DC), alternating current (AC), radio-frequency (RF) and other discharges. DC PLATO are the most commonly used and researched, because when compared to AC, these offer reduced flicker generation and noise, more stable operation, better control, a minimum of two electrodes, lower electrode consumption, slightly lower refractory [heat] wear and lower power consumption.

As depicted the process comprises first to eighth steps 1210 to 1280 respectively, the being:
First step 1210 wherein a plasma torch (PLATO) attached to a CU-MACTO according to an embodiment of the invention is moved to a predetermined position relative to the grating, for example, the mid-point of the grating element (e.g. a long axis grating element or a short axis grating element), the PLATO is initiated, and a predetermined delay is waited to verify that the PLATO has been struck (i.e. the plasma “lit”).
Second step 1220 wherein the PLATO moves to a predetermined cut height which may be established relative to the grating through one or more methods such as employing a force motion detector upon the PLATO to define initial contact of the PLATO to the grating upper surface or monitoring the arc voltage;
Third step 1230 wherein the PLATO moves towards a first edge of the grating element which is defined through monitoring the arc voltage, for example;
Fourth step 1240 wherein the PLATO upon detecting the edge retracts to a predetermined retraction distance and waits a predetermined dwell delay;
Fifth step 1250 wherein the PLATO moves back to the start position, and the PLATO is re-ignited just in case the arc has been lost;
Sixth step 1260 wherein the PLATO moves towards the second edge of the grating element which is defined through monitoring the arc voltage, for example;
Seventh step 1270 wherein the PLATO upon detecting the edge retracts to the predetermined retraction distance and waits a predetermined dwell delay; and
Eighth step 1280 wherein the PLATO is “turned off”.

During the steps where the PLATO is moved relative to the grating elements such as establishing the PLATO at the mid-point of the grating element or detecting the edges then motion of the PLATO and monitoring of the plasma voltage is employed to detect changes and the CU-MATCO, to which the PLATO is connected, can then determine an action in response to the detected change. This may be a predetermined change in plasma voltage (or arc voltage) or a predetermined profile/trend within the measured plasma voltage (or arc voltage).

Similarly, at specific points such as first step 1210 and fifth step 1250 a spike in arc voltage may occur at ignition of the plasma so that employing a predetermined dwell allows for any spike in arc voltage to occur and not be included in any decision making process based upon monitoring of the arc voltage. Similarly, at third step 1230 and sixth step 1260 the PLATCO dwells for a predetermined period of time at the point the edge is detected in order to ensure that the PLATCO has cut through the edge of the grating element. Optionally, motion of the PLATCO may be a simple linear motion, a rectangular motion overall, an elliptical motion etc.

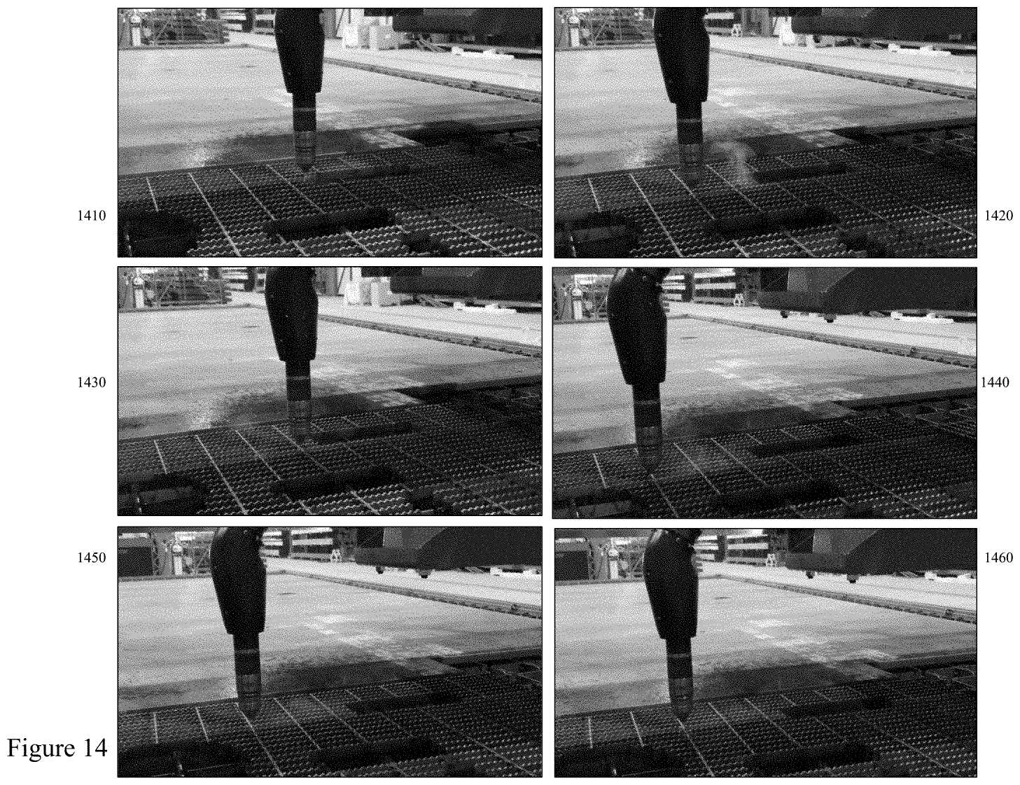

It would be evident that where the grating element is circular that the process at third and fourth steps 1230 and 1240 respectively together with the process at fifth and sixth steps 1260 and 1270 respectively may be varied such that as the PLATO detects an initial reduction in arc voltage, as the grating element—PLATO spacing increases then the PLATO executes a predetermined motion of the PLATO relative to a predetermined point established with respect to the grating element, e.g. a rotation. Such a rotation as the PLATO moves from the centre of the grating to the two edges of the grating element being depicted in FIG. 13 through first to third images 1310 to 1330 respectively which depict the PLATO rotated to a first angular offset, α₁, the PLATO at its default position, and rotated to a second angular offset, α₂. For example, α₁=−α₂. Such a rotation may help to ensure that the torch is pointed to the grating element (e.g. bar) and the torch ignited. Optionally, the predetermined motion of the PLATO relative to a predetermined point established with respect to the grating element may be different for each side of the grating element as the grating element may be asymmetric.

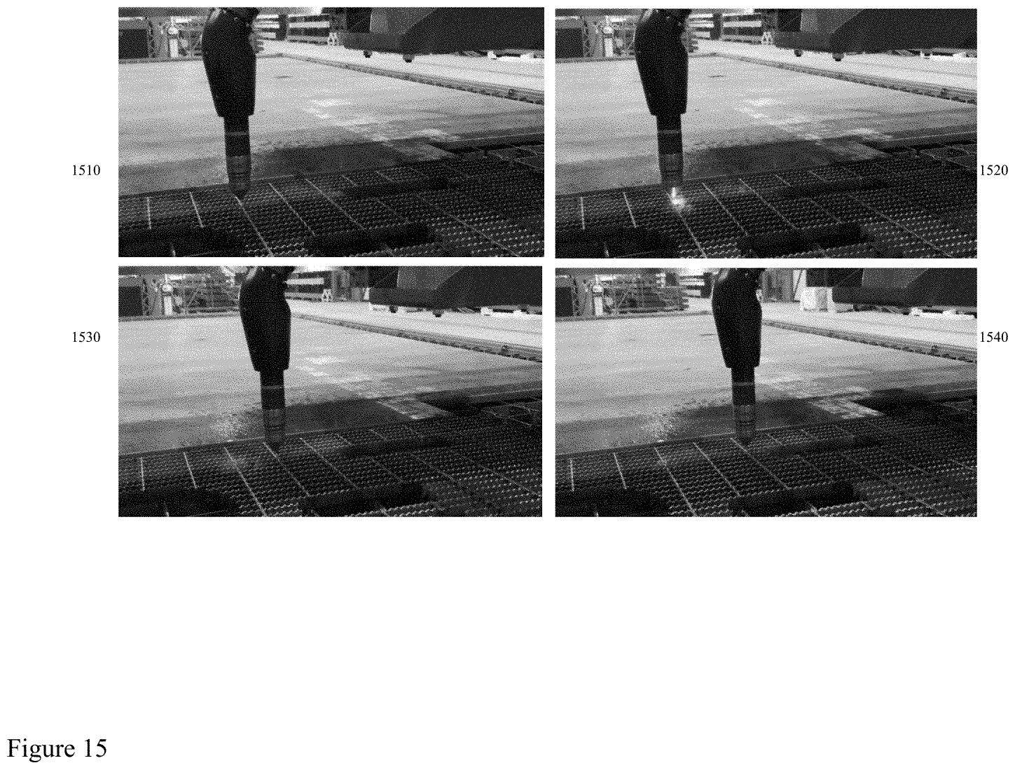

Referring to FIGS. 14 and 15 there are depicted first to tenth images 1410 to 1460 and 1510 to 1540 of a PLATCO mounted to a CU-MATCO (PLACUMA) exploiting an exemplary tool process according to an embodiment of the invention to cut a defined grating, a rectangular grating, from a grating sheet next to one already cut out (as evident from the missing portion in the images). Accordingly, these images depict:
First image 1410 wherein the PLACUMA is at a starting position;
Second image 1420 wherein the PLACUMA is moved to a first grating element to cut, a short axis grating element in the middle of a first long side of the rectangular grating;
Third image 1430 wherein the PLACUMA is moved to a second grating element to cut, another short axis grating element at one end of the first long side of the rectangular grating;
Fourth image 1440 wherein the PLACUMA is moved to a third grating element to cut, another short axis grating element at the other end on the first long side of the rectangular grating;
Fifth image 1450 wherein the PLACUMA is moved to a fourth grating element to cut, a first long axis grating element on the short side of the rectangular grating still attached to the grating sheet;
Sixth image 1460 wherein the PLACUMA is moved to a fifth grating element to cut, a second long axis grating element on the short side of the rectangular grating still attached to the grating sheet;
Seventh image 1510 wherein the PLACUMA is moved to a sixth grating element to cut, a third long axis grating element on the short side of the rectangular grating still attached to the grating sheet;
Eighth image 1520 wherein the PLACUMA is cutting the seventh grating element to cut, the other end of the third short axis grating element;
Ninth image 1530 wherein the PLACUMA is cutting the eighth grating element to cut, the other end of the first short axis grating element; and
Tenth image 1540 wherein the PLACUMA is cutting the ninth grating element to cut, the other end of the second short axis grating element, thereby cutting the final grating element linking the grating to the grating sheet.

Within the embodiments of the invention presented above in respect of FIGS. 1 to 15 the locations of cross-overs between long axis elements sheet and short axis elements the grating or grating sheet can vary through factors including the underlying design of the grating or grating sheet, manufacturing inconsistencies in the placement of the long axis elements and/or short axis elements, and that the grating or grating sheet being processed is formed from multiple gratings, portions of gratings, grating sheets or grating sheets. Further, a wide range of grating sheet geometries may be employed with rectangular, square, circular cross-section short axis elements with typically rectangular long axis elements although other geometries, pitches, element dimensions, may be employed. Accordingly, it would be beneficial to provide operators of CU-MATCOs with an automated method of determining cross-overs between short axis elements and long axis elements.

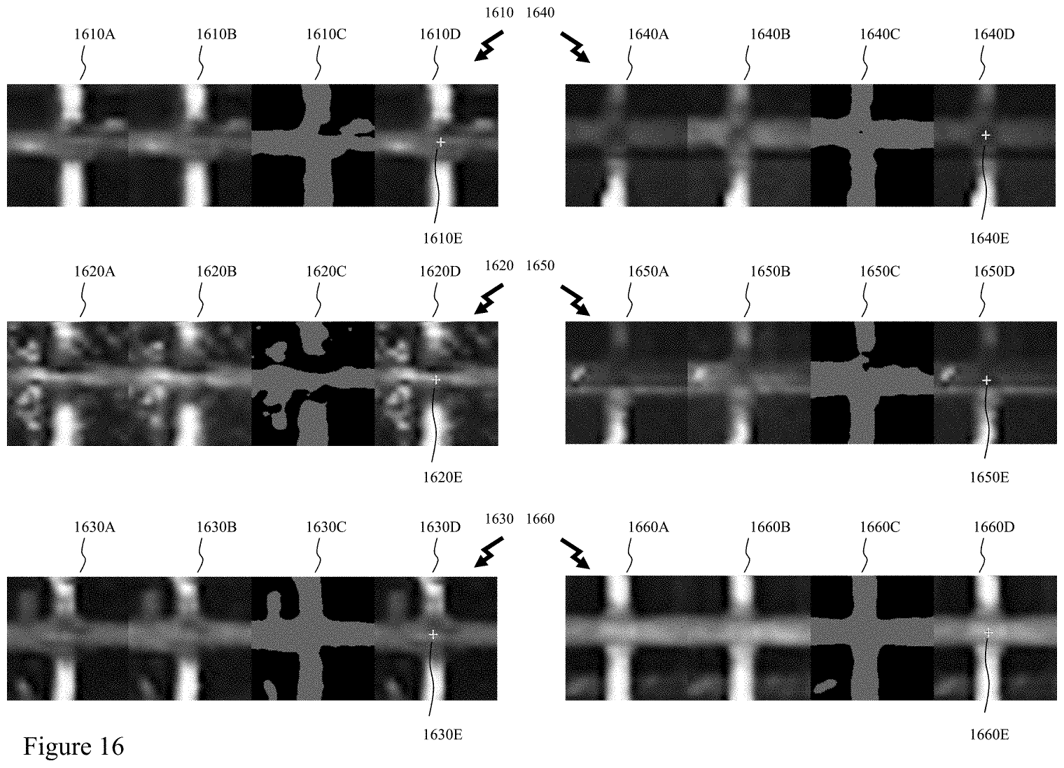

Referring to FIG. 16 there are depicted first to sixth image sets 1610 to 1660 respectively relating to image acquisition, processing, and cross-over determination according to embodiments of the invention. Accordingly, within each of the first to sixth image sets 1610 to 1640 respectively there are presented:
Initial acquired images 1610A, 1620A, 1630A, 1640A, 1650A and 1660A respectively;
Grayscale images 1610B, 1620B, 1630B, 1640B, 1650B and 1660B respectively derived from the initially acquired images 1610A, 1620A, 1630A, 1640A, 1650A and 1660A respectively using one or more first image processing algorithms;
Threshold images 1610C, 1620C, 1630C, 1640C, 1650C and 1660C respectively derived from the initially acquired images 1610B, 1620B, 1630B, 1640B, 1650B and 1660B respectively using one or more second image processing algorithms; and
Acquired images 1610A, 1620A, 1630A, 1640A, 1650A and 1660A respectively with determined cross-over locations 1610E, 1620E, 1630E, 1640E, 1650E, and 1660E respectively for each of the acquired images 1610A, 1620A, 1630A, 1640A, 1650A and 1660A respectively using one or more third image processing algorithms.

Accordingly, each of the determined cross-over locations 1610E, 1620E, 1630E, 1640E, 1650E, and 1660E respectively is defined with respect to the acquired and processed image of the respective grating cross-over within the grating or grating sheet. It would be evident to one of skill in the art that the image processing sequence may also be employed on images of the grating sheet or grating acquired without cross-overs in order to define the mid-point of a long axis element or short axis element. Within embodiments of the invention the acquired images 1610A, 1620A, 1630A, 1640A, 1650A and 1660A respectively may be captured individually as the CU-MATCO executes a mapping process to determine cross-over locations or they may be established through an initial image processing applied to acquired images which contain multiple cross-overs. The balance between a large number of individual image acquisitions versus processing a smaller number of acquired images with resulting lower resolution image for each cross-over may be established in dependence upon factors including, but not limited to, target processing time, camera resolution, CU-MATCO processing capabilities, and target cutting accuracy. Alternatively, the individual images may be acquired based upon the CU-MATCO having a grating design already established so that the CU-MATCO may follow the outline of the grating design and establish locations of cross-overs to then define elements and therein the cutting locations.

The established cross-over locations 1610E, 1620E, 1630E, 1640E, 1650E, and 1660E respectively may within embodiments of the invention be employed directly in conjunction with a grating design, such as grating design 810 in FIG. 8, or they may be employed to establish a grating grid, such as depicted for example in FIG. 7 with first to third grating grids 710 to 730 respectively. Accordingly, for example, linear fits to the established cross-over locations may be employed to define the long axis elements and/or short axis elements. Optionally, a higher order polynomial fit might be employed or a piece-wise linear fit. Other fitting methodologies may be employed without departing from the scope of the invention. The established cross-over locations may be stored within a database as a plurality of cross-over coordinate sets which are then processed to define the grating or grating sheet.

Accordingly, the established cross-over locations 1610E, 1620E, 1630E, 1640E, 1650E, and 1660E respectively may be employed directly or indirectly to define the locations of cutting points of one or more gratings and/or grating sheets in order to implement a grating design, such as grating design 810 in FIG. 8. Accordingly, the automated determination of the established cross-over locations 1610E, 1620E, 1630E, 1640E, 1650E, and 1660E respectively means that a user does not need to define one or more gratings and/or grating sheets placed upon the CU-MATCO to be processed. Directly defining a location of a cutting point may be based, for example, upon the CU-MATCO taking the nearest determined cross-over or element location to a portion of the grating design. Indirectly defining a location of a cutting point may be based, for example, upon determining a projection for an element of a grating or a portion of an element of a grating using two or more defined locations of cross-overs, for example, and then using this projection (e.g. linear fit, piece-wise linear fit, etc.) to define an intersection with a grating design.

It would be evident that the references to long axis elements and short axis elements are intended to help the person of ordinary skill in the art reading this specification to visualize the processes and designs of gratings and/or grating sheets processed with CU-MATCOs exploiting embodiments of the invention. However, such references are not absolute as a grating or grating sheet may be square, a regular polygon, irregular etc. Further, whilst embodiments of the invention have been described and depicted with the long axis elements and short axis elements crossing over approximately orthogonally (i.e. at 90°) to each other it would be evident that the cross-over angle may be non-orthogonal with intersection angles such as 30°, 45° etc. All such variations being supported by embodiments of the invention.

The embodiments of the invention presented above in respect of FIGS. 1 to 16 have been primarily presented with respect to settings/processes exploiting laser welding and/or plasma cutting systems. However, it would be apparent to one of skill in the art that the methodologies may alternatively be associated with a tool rather than the machine or with respect to a consumable of a tool and/or machine. Further, these processes and methodologies may also be applied to range of other manufacturing processes and/or machines including, but not limited to, machining, milling, welding, cutting, forming, welding, and 3D printing with processes exploiting additive and/or removal processes such as plasma, laser, thermal, fluid etc.

Within embodiments of the invention standard process libraries may be updated such as described by the inventors within U.S. patent application Ser. No. 15/266,404 filed Sep. 15, 2016 entitled “Client Initiated Vendor Verified Tool Setting.”

Within embodiments of the invention the operator may exploit one or more standard templates to define a control file to fit a piece of raw material or alternatively create a control file and then exploit the processes as described with respect to embodiments of the invention to verify/execute them and achieve finished processing with reduced processing time. Such templates may be as described by the inventors within U.S. patent application Ser. No. 15/450,189 filed Mar. 6, 2017 entitled “Direct Client Initiated CNC Tool Setting.”

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof. Databases as referred to herein may also refer to digital repositories of content or other digitally stored content within a collection which may be indexed or non-indexed.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
acquiring a plurality of images, each image acquired with a camera of one or more grating sheets upon a computer controlled cutting machine tool (CU-MATCO) where each grating sheet comprises a plurality of grating elements in a predetermined pattern;
processing the plurality of images with a microprocessor to define a plurality of sets of location data, each set of location data defining at least one of a grating element within the one or more grating sheets and a cross-over between a pair of grating elements within the one or more grating sheets;
retrieving from a database a template of a grating to be cut from the one or more grating sheets;
generating with the microprocessor a plurality of cut locations, each cut location representing a location upon a grating element of the plurality of grating elements at which a cut should be made within the grating element of the plurality of grating elements, the plurality of cut locations being established in dependence upon the template and the plurality of sets of location data; and
making each cut of the plurality of cuts with a cutter forming part of the CU-MATCO.

2. The method according to claim 1, wherein
making each cut of the plurality of cuts comprises:
moving the cutter to a predetermined position relative to the grating element being cut;
moving the cutter to a first predetermined height relative to the grating element being cut;
moving the cutter in a first direction from the predetermined position to a first edge of the grating element being cut;
upon detecting the first edge of the grating element being cut moving the cutter to a second predetermined height relative to the grating element being cut and waiting for a first predetermined time;
moving the cutter to the predetermined position relative to the grating element being cut;
moving the cutter to the first predetermined height relative to the grating element being cut;
moving the cutter in a second direction from the predetermined position to a second edge of the grating element being cut; and
upon detecting the second edge of the grating element being cut moving the cutter to a third predetermined height relative to the grating element being cut and waiting for a second predetermined time.

3. The method according to claim 2, further comprising
upon detecting the first edge of the grating element performing a first predetermined motion relative to the grating element; and
upon detecting the first edge of the grating element performing a second predetermined motion relative to the grating element.

4. The method according to claim 3, wherein
the grating element is circular;
the first predetermined motion is a rotation in one direction within a plane perpendicular to the axis of the grating element; and
the second predetermined motion is a rotation in another one direction within the plane perpendicular to the axis of the grating element.

5. The method according to claim 1, wherein
the plurality of images are acquired and processed prior to a first cut of the plurality of cuts are made.

6. The method according to claim 1, wherein
subsets of the plurality of images are acquired and processed and cut subsets of the plurality of cuts are made.

7. The method according to claim 2, wherein
the cutter is a plasma torch; and
detecting an edge of the grating element comprises:
monitoring the arc voltage of the plasma torch; and
determining whether the arc voltage of the plasma torch either varies beyond a predetermined threshold or varies in a predetermined manner.

8. A method comprising:
acquiring a location of a cut to be made upon a grating element within a grating sheet;
making the cut with a cutter on computer controlled machine tool; wherein
making the cut comprises:
moving the cutter to a predetermined position relative to the grating element being cut;
moving the cutter to a first predetermined height relative to the grating element being cut;
moving the cutter in a first direction from the predetermined position to a first edge of the grating element being cut;
upon detecting the first edge of the grating element being cut moving the cutter to a second predetermined height relative to the grating element being cut and waiting for a first predetermined time;
moving the cutter to the predetermined position relative to the grating element being cut;
moving the cutter to the first predetermined height relative to the grating element being cut;
moving the cutter in a second direction from the predetermined position to a second edge of the grating element being cut; and
upon detecting the second edge of the grating element being cut moving the cutter to a third predetermined height relative to the grating element being cut and waiting for a second predetermined time.

9. The method according to claim 8, further comprising
upon detecting the first edge of the grating element performing a first predetermined motion relative to the grating element; and
upon detecting the first edge of the grating element performing a second predetermined motion relative to the grating element.

10. The method according to claim 9, wherein
the grating element is circular;
the first predetermined motion is a rotation in one direction within a plane perpendicular to the axis of the grating element; and
the second predetermined motion is a rotation in another one direction within the plane perpendicular to the axis of the grating element.

11. The method according to claim 9, wherein
acquiring the location of the cut to be made upon the grating element within the grating sheet comprises:
acquiring a set of initial images of the grating sheet;
processing each initial image of the acquired set of initial images with a plurality of image processing elements to define one or more cross-overs with the initial image of the acquired set of initial images;
generating a plurality of cross-over coordinates, each cross-over coordinate relating to a central point of a crossing between a first element of a plurality of elements and a second element of a plurality of elements where the grating element is one element of the plurality of elements;
processing plurality of cross-over coordinates to define locations of a plurality of elements of which the grating element is one;
processing the locations of the plurality of elements in conjunction with a grating design to define a plurality of cut locations of which the location of the cut is one.

12. The method according to claim 9, wherein
acquiring the location of the cut to be made upon the grating element within the grating sheet comprises:
acquiring a set of initial images of the grating sheet;
processing each initial image of the acquired set of initial images with a plurality of image processing elements to one or more elements of a plurality of elements of which the grating element is one;
generating a plurality of element coordinates, each element coordinate relating to a central point of a first element of a plurality of elements where the grating element is one element of the plurality of elements;
processing the plurality of element coordinates to define locations of the plurality of elements of which the grating element is one;
processing the locations of the plurality of elements in conjunction with a grating design to define a plurality of cut locations of which the location of the cut is one.

13. A method comprising:
acquiring a plurality of images, each image acquired with a camera of one or more grating sheets upon a computer controlled cutting machine tool (CU-MATCO) where each grating sheet comprises a plurality of grating elements in a predetermined pattern;
processing the plurality of images with a microprocessor to define a combined image, the combined image being of a predetermined portion of the grating sheet;
displaying the combined image to a user within a graphical user interface together with a grid template, the grid template comprising a grid having a plurality of vertices representing a virtual grating sheet;
providing the user with the ability to move any vertex of the plurality of vertices to align the grid template with the combined image;
retrieving from a database a template of a grating to be cut from the one or more grating sheets;
generating with the microprocessor a plurality of cut locations, each cut location representing a location upon the one or more grating sheets established in dependence upon the template and the aligned grid template; and
making each cut of the plurality of cuts with a cutter forming part of the CU-MATCO.

14. The method according to claim 13, wherein
making each cut of the plurality of cuts comprises:
moving the cutter to a predetermined position relative to the grating element being cut;
moving the cutter to a first predetermined height relative to the grating element being cut;
moving the cutter in a first direction from the predetermined position to a first edge of the grating element being cut;
upon detecting the first edge of the grating element being cut moving the cutter to a second predetermined height relative to the grating element being cut and waiting for a first predetermined time;
moving the cutter to the predetermined position relative to the grating element being cut;
moving the cutter to the first predetermined height relative to the grating element being cut;
moving the cutter in a second direction from the predetermined position to a second edge of the grating element being cut; and
upon detecting the second edge of the grating element being cut moving the cutter to a third predetermined height relative to the grating element being cut and waiting for a second predetermined time.

15. The method according to claim 14, further comprising
upon detecting the first edge of the grating element performing a first predetermined motion relative to the grating element; and
upon detecting the first edge of the grating element performing a second predetermined motion relative to the grating element.

16. The method according to claim 15, wherein
the grating element is circular;
the first predetermined motion is a rotation in one direction within a plane perpendicular to the axis of the grating element; and
the second predetermined motion is a rotation in another one direction within the plane perpendicular to the axis of the grating element.
